(19) United States
(12) Patent Application Publication
(10) Pub. No.: US 2016/0006760 A1
(43) Pub. Date: Jan. 7, 2016

(54) DETECTING AND PREVENTING PHISHING ATTACKS

(71) Applicant: Microsoft Corporation, Redmond, WA (US)

(72) Inventors: Nazim I. Lala, Woodinville, WA (US); Ashish Kurmi, Redmond, WA (US); Richard Kenneth Mark, Redmond, WA (US); Shrikant Adhikarla, Redmond, WA (US)

(21) Appl. No.: 14/322,232

(22) Filed: Jul. 2, 2014

(51) Int. Cl. H04L 29/06

(52) U.S. Cl. CPC H04L 63/1483; H04L 63/1416

(57) ABSTRACT

Embodiments are directed to detecting and preventing phishing attacks. In one scenario, a computer system accesses a message and analyzes content in the message to determine whether a link is present. The link has a link destination and at least some text that is designated for display in association with the link (i.e. the anchor), where the text designated for display indicates a specified destination. Then, upon determining that a link is present in the message, the computer system determines whether the link destination matches the destination specified by the text designated for display and, if it determines that the destination specified by the text designated for display does not match the link destination, the computer system flags the message to indicate that the message includes at least one suspicious link.

### BACKGROUND

Internet browsers allow users to view and interact with web pages at website locations all over the world. Most of these websites, whether private or public, personal or business, are legitimate and pose no threat to their users. However, some websites attempt to take on the look and feel of legitimate websites in order to trick users into divulging personal, potentially sensitive information such as user names and passwords. This malicious practice is commonly known as “phishing”. It often shows up in emails which include links to seemingly legitimate websites that turn out to be malicious.

### BRIEF SUMMARY

Embodiments described herein are directed to detecting and preventing phishing attacks. In one embodiment, a computer system accesses a message and analyzes content in the message to determine whether a link is present. The link has a link destination and at least some text that is designated for display in association with the link (i.e. the anchor), where the text designated for display indicates a specified destination. Then, upon determining that a link is present in the message, the computer system determines whether the link destination matches the destination specified by the text designated for display and, if it determines that the destination specified by the text designated for display does not match the link destination, the computer system flags the message to indicate that the message includes at least one suspicious link.

In another embodiment, a computer system receives an indication indicating that a specified link has been selected. The link has a link destination and at least some text that is designated for display in association with the link, where the text designated for display indicates a specified destination. The computer system determines whether the link destination matches the destination specified by the text designated for display and, upon determining that the destination specified by the text designated for display does not match the link destination, the computer system triggers a warning to indicate that the link is suspicious.

In still another embodiment, a computer system identifies sensitive information associated with a user. The computer system receives a server request indicating that data, including at least some sensitive information, is to be transferred to a server and determines a destination address indicating where the sensitive information is to be sent. The computer system then determines that the destination address is unlisted within a known-safe list and, upon determining that the at least one portion of sensitive information is to be sent to a destination that is not listed in the known-safe list, the computer system triggers a warning to indicate that received server request includes sensitive data and is being sent to a location that is not known to be safe.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including detecting and preventing phishing attacks.

FIG. 2 illustrates a flowchart of an example method for detecting and preventing phishing attacks.

FIG. 3 illustrates a flowchart of an alternative example method for detecting and preventing phishing attacks.

FIG. 4 illustrates a flowchart of an alternative example method for detecting and preventing phishing attacks.

FIG. 5 illustrates an alternative computing architecture in which embodiments described herein may operate including detecting and preventing phishing attacks.

FIGS. 6A and 6B illustrate embodiments of HTML anchor tags.

### DETAILED DESCRIPTION

Embodiments described herein are directed to detecting and preventing phishing attacks. In one embodiment, a computer system accesses a message and analyzes content in the message to determine whether a link is present. The link has a link destination and at least some text that is designated for display in association with the link (i.e. the anchor), where the text designated for display indicates a specified destination. Then, upon determining that a link is present in the message, the computer system determines whether the link destination matches the destination specified by the text designated for display and, if it determines that the destination specified by the text designated for display does not match the link destination, the computer system flags the message to indicate that the message includes at least one suspicious link.

In another embodiment, a computer system receives an indication indicating that a specified link has been selected. The link has a link destination and at least some text that is designated for display in association with the link, where the text designated for display indicates a specified destination. The computer system determines whether the link destination matches the destination specified by the text designated for display and, upon determining that the destination specified by the text designated for display does not match the link destination, the computer system triggers a warning to indicate that the link is suspicious.

In still another embodiment, a computer system identifies sensitive information associated with a user. The computer system receives a server request indicating that data, including at least some sensitive information, is to be transferred to a server and determines a destination address indicating where the sensitive information is to be sent. The computer system then determines that the destination address is unlisted within a known-safe list and, upon determining that the at least one portion of sensitive information is to be sent to a destination that is not listed in the known-safe list, the computer system triggers a warning to indicate that received server request includes sensitive data and is being sent to a location that is not known to be safe.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

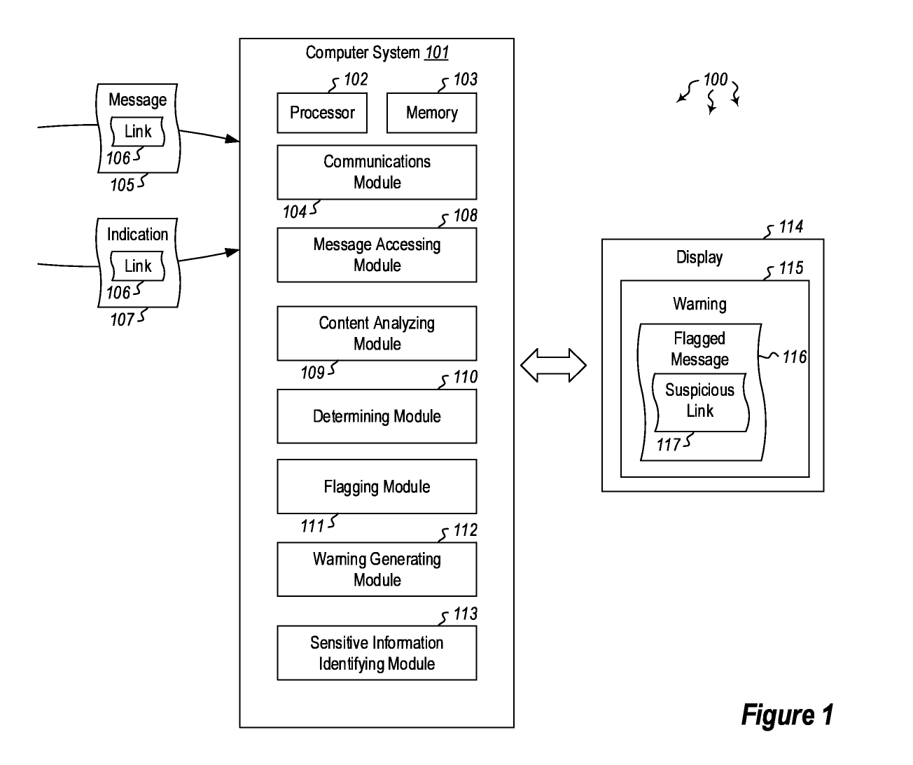

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer system 101 may be any type of local or distributed computer system, including a cloud computing system. The computer system 101 includes modules for performing a variety of different functions. For instance, the communications module 104 may be configured to communicate with other computing systems. The computing module 104 may include any wired or wireless communication means that can receive and/or transmit data to or from other computing systems. The communications module 104 may be configured to interact with databases, mobile computing devices (such as mobile phones or tablets), embedded or other types of computing systems.

Computer system 101 further includes a message accessing module 108 which is configured to access messages such as message 105. The messages may be email messages, text messages or other types of messages that may include hyperlinks (e.g. 106). The content analyzing module 109 of computer system 101 may be configured to analyze the message's content to determine whether a hyperlink or “link” exists within the content. In some embodiments, the content analyzing module 109 may be configured to analyze other forms of content including images, videos or any other kind of media or other content that may include a link that could be used for phishing. The determining module 110 may analyze the link 106 to determine whether it appears to be suspicious or not. A link may be deemed “suspicious” if there are inconsistencies such as mismatched display text and link destination, or if there are other irregularities or specified properties that would indicate a phishing attempt.

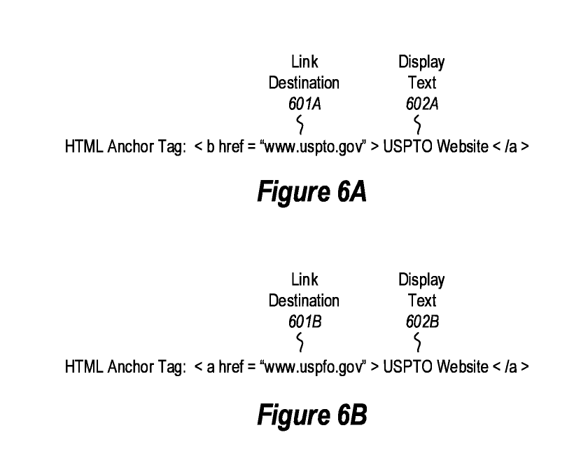

Indeed, as shown in FIG. 6A, an HTML anchor tag may include a link destination 601A (e.g. “www.uspto.gov”) and a portion of display text 602A (“USPTO Website” in FIG. 6A. Phishing attacks often attempt to impersonate websites, building sites that are identical to the authentic site, while having a link destination that is only slightly different. Thus, as is shown in FIG. 6B, the link destination 601B may be “www.uspfo.gov” or “www.usplo.gov” or some other similar-looking variation. The display text 602B may be exactly the same as that in FIG. 6A. Thus, unless the user is paying close attention, they may not notice that the website they requested (by mistyping for example) is not the site they actually intended to go to. Once at the malicious website, the user is susceptible to providing sensitive information into attackers' hands. Accordingly, in embodiments herein, the determining module 110 of computer system 101 may determine that a link's link destination does not match its display text, and may trigger a warning 115 to the user, notifying them that the link they are about to select or have selected (e.g. by clicking or touching) is suspicious and may be malicious.

Accordingly, embodiments described herein are designed to prevent users from following possibly malicious links where the anchor or display text differs from the href link destination, and to further prevent users from accidently sending domain credentials to a malicious actor. The sensitive information identifying module 113 of computer system 101 may be configured to identify when a user is entering and/or sending sensitive information (such as user name and password) to a website that is known to be unsafe or is not known to be safe or meets other qualifying characteristics. For instance, embodiments may attempt to determine if the user's credentials are intended for a specified domain, and may provide a warning 115 before passing that set of credentials to any server outside of that domain (e.g. outside a corporate intranet or outside the user's user principal name (UPN) suffix, where the default UPN suffix for a user account is the Domain Name System (DNS) domain name of the domain that contains the user account). The computing system 011 may further be configured to evaluate link texts against anchors and implement the flagging module 111 to flag mismatches when present.

The sensitive information identifying module 113 may be configured to monitor key strokes on a keyboard, touch input on a smart phone or other mobile device, or monitor other types of user inputs such as gestures or mouse clicks. The sensitive information identifying module 113 may learn, over time, which of the user's information is sensitive information. For example, the sensitive information identifying module 113 may use text analysis to determine when user names or passwords are being entered, or when strings of numbers (e.g. phone numbers, Social Security numbers, birthdates, credit card numbers, bank account numbers, etc.) are being entered. The sensitive information identifying module 113 may be constantly monitoring user inputs to determine when sensitive information has been entered, and may then determine where that sensitive information is to be sent.

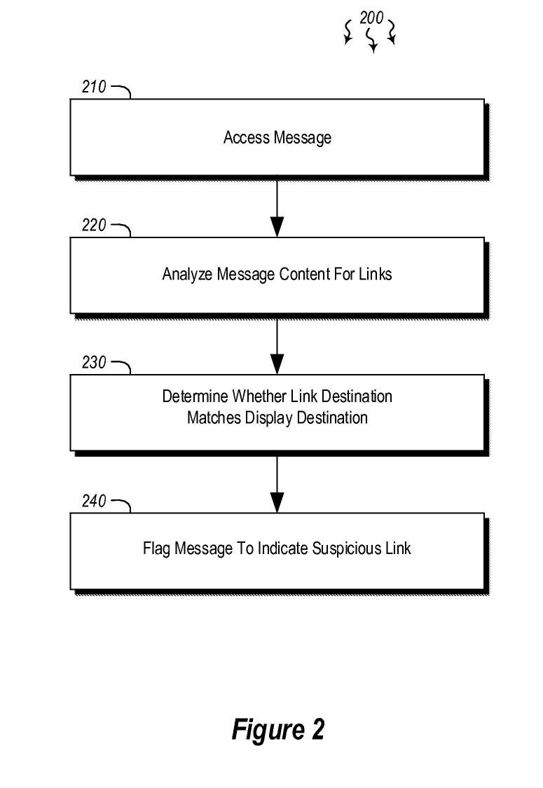

If the sensitive information is to be sent to a known safe destination server, data will be sent without warning. If, however, the user's sensitive data is to be sent to an unknown destination or to a known unsafe destination server, a warning 115 will be generated and the user's data will not be transferred. Such events may be tracked and corresponding information including which data was to be sent and where the data was to be sent to may be logged. Such logging information may be stored in a data store and/or transmitted to other locations/entities for further analysis. If a user is sending sensitive information to a site that they recognize as safe, the warning 115 may be overridden and the sensitive information may be transferred despite the warning. Warnings may also be generated as soon as a user name or password field is detected on an untrusted site. The determining module 110 may determine that the domain is not trusted and that the web page has fields and words similar to “user name” or “password”. In such cases, the user may be preemptively warned that the web site may be phishing for sensitive information. These concepts will be explained further below with regard to methods 200, 300 and 400 of FIGS. 2, 3 and 4, respectively.

In view of the systems and architectures described above, methodologies that may be implemented in accordance with the disclosed subject matter will be better appreciated with reference to the flow charts of FIGS. 2, 3 and 4. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for detecting and preventing phishing attacks. The method 200 will now be described with frequent reference to the components and data of computing environment 100.

Method 200 includes an act of accessing at least one message (act 210). For example, message accessing module 108 may access message 105. The message 105 may be an email message, a text message or some other form of content that is capable of including a hyperlink. The message 105 may be scanned as part of a service that scans email or text messages before delivering them to the end user. Or the message 105 may be scanned by an application running on the end user's electronic device (e.g. a browser or email application). In some cases, the message may be scanned by a service running as a plug-in to another application. This service may identify all of the links that are present in the message.

Method 200 next includes an act of analyzing content in the message to determine whether a link is present, the link having a link destination and at least a portion of text that is designated for display in association with the link, the text designated for display indicating a specified destination (act 220). The content analyzing module 109 may analyze the content of the message 105 to determine whether any links 106 are present in the message. The content analyzing module 109 may be configured to look for hyper-text markup language (HTML) hyperlinks or other types of links. These links allow users to select the link and be navigated to a destination specified in the link. For example, as shown in FIG. 6A, the link destination 601A in the anchor tag (<a>) is an href destination and is designated as “www.uspto.gov”. The display text 602A that is actually displayed on a browser or within an email and is seen by the user is “USPTO Website”. This text may, however, be any text string including “click here” or similar. Thus, while the display text may say one thing, the actual link destination may be totally different. And in some cases, the link destination and display text may be intentionally confusingly similar (as in FIG. 6B where the link destination 601B is “www.uspfo.gov” and the display text 602B is USPTO Website).

Upon determining that at least one link is present in the message 105, method 200 includes an act of determining whether the link destination matches the destination specified by the text designated for display (act 230). In the example embodiment shown in FIG. 6A, the link destination 601A does match the display text 602A, while in the example embodiment of FIG. 6B, the link destination 601B does not match the display text 602B. If the determining module 110 determines that the destination specified by the text designated for display (e.g. 602A) does not match the link destination (e.g. 601A), method 200 performs an act of flagging the message to indicate that the message includes at least one suspicious link (act 240). The flagging module 111 may thus flag the message 105 that was determined to have a link with mismatched link destination and display text. The flagged message 116 may be displayed on display 114 and may include a red flag symbol or other marker letting the user know that the message has a suspicious link 117. Additionally or alternatively, the flagged message may be displayed as part of a warning 115 that is generated to notify the user that they should reconsider navigating to that link.

Indeed, the message 105 may be flagged with a notification notifying a message recipient that the message is not to be opened or that the link is not to be followed. If the user recognizes the link destination and determines it to be safe, the user can ignore the warning and proceed. In some cases, however, such as cases where the user is attempting to navigate to a known unsafe site, the browser, email client or whatever application or service is performing the message analysis may prevent the user from navigating to the link destination by preventing any data requests from being sent to that location. Still further, in cases of flagged messages, users may be prevented from interacting with links at all within the message, or at least from certain links within the message. Interaction may include clicking the link with a mouse, hovering over the link, selecting the link with a gesture or touch, selecting the link with a voice command, or in some other way interacting with the link that could cause navigation to begin and data to be transferred or requested.

Once a message has been flagged as having a potentially suspicious link, the computer system 10 may generate logging information to log details related to the flagged message including when the message was received, who the message was from, the general or specific contents of the message, the actual link including link destination and display text or any other related data that may be useful in determining the originator of the message. This logging information may be stored locally or remotely in a data store, or may be transferred to another location or entity for further analysis. For example, it may be advantageous to maintain a database of known phishing websites, known messages that include links to phishing websites, known senders of messages that include phishing links, etc.

In some cases, when the determining module 110 determines that the link destination is associated with a location that is known to be unsafe, the warning generating module 112 may generate a warning 115 that includes an indication of the link(s) determined to be suspicious. The warning may display both the link's display text and its associated link destination. In this manner, a user may be able to view the link's display text and link destination and determine that there is indeed a display text/link destination mismatch and that the link destination is not the user's intended destination. Alternatively, the user may view the link destination and may determine that, despite the mismatch or despite the detection of any other characteristics that would indicate that the link is suspicious, the user knows the destination to be safe and wishes to navigate there despite the warning. At this stage, the user may also be offered a button or other UI item to indicate that the link destination site is known to the user to be a safe site and should not be flagged in further message scans. The site is then added to a known safe list. Down the road, when subsequent messages that include the specified link destination are received, the service or application will prevent them from being flagged as suspicious, as they are known to be safe.

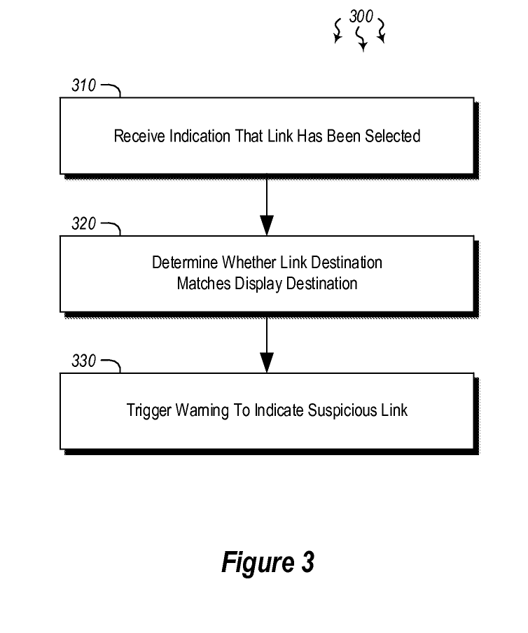

Turning now to FIG. 3, a flowchart is illustrated of a method 300 for detecting and preventing phishing attacks. The method 300 will now be described with frequent reference to the components and data of computing environment 100.

Method 300 includes an act of receiving an indication indicating that a specified link has been selected, the link having a link destination and at least a portion of text that is designated for display in association with the link, the text designated for display indicating a specified destination (act 310). For example, a browser application, message scanning service or other phishing prevention service may receive an indication 107 indicating that a specified link 106 has been selected in some manner. The link, as mentioned above, includes a link destination and some portion of displayed text that allows the user to see the link. The determining module 110 may determine whether the link destination matches the destination specified by the display text (act 320). If the determining module 110 determines that the destination specified by the display text does not match the link destination, method 200 performs an act of triggering a warning to indicate that the link is suspicious (act 330). The warning generating module 112 may thus generate a warning that notifies the user that the link they have selected is suspicious in some manner, and should not be navigated to.

In at least one embodiment, the indication indicating that a specified link has been selected is received at a web browser application. This indication may be received by the browser itself, or by a plug-in running on the browser. The indication may, for example, be triggered by a user interaction with the web browser application. The user may, for example, be viewing email through an email portal. That email may include a message that has a link and the user may select that link in some manner. This would trigger an analysis of the link's destination and display text. If the analysis indicated that the link was suspicious in some way, the indication would be sent to the browser which would display a warning and/or prevent the data request (generated by the hyperlink selection) from being transmitted.

Thus, in this manner, the user's interactions with the web browser may be monitored and analyzed to ensure that the user is not attempting to navigate using a suspicious link. If at any time in the user's browsing the destination specified by the display text does not match the link destination, the web browser application may prevent the user's interaction with the web browser from navigating to the link, or at least display a warning indicating that the link destination is not known to be safe. Such warning messages may be suppressible by the user upon determining that the link destination is a known safe destination, or that the domain name system (DNS) will automatically redirect the user to the correct website.

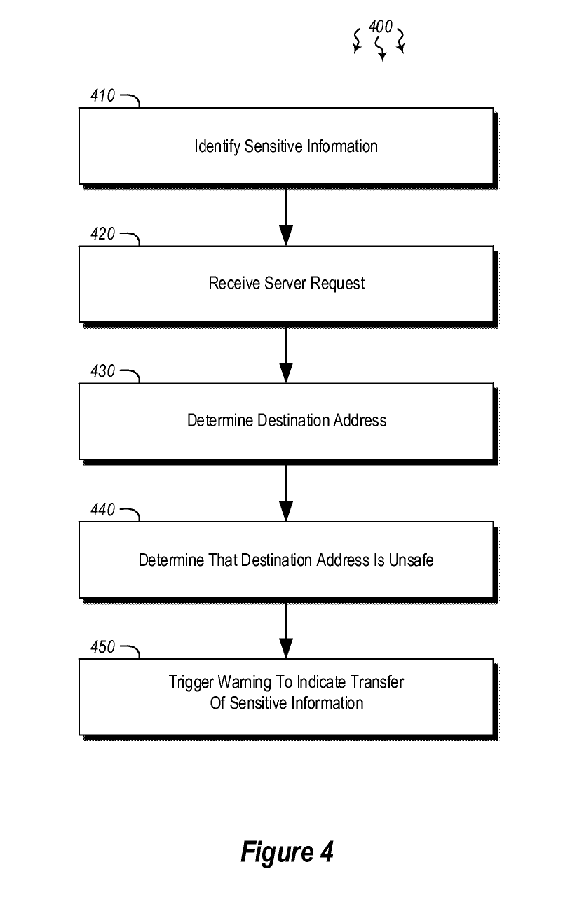

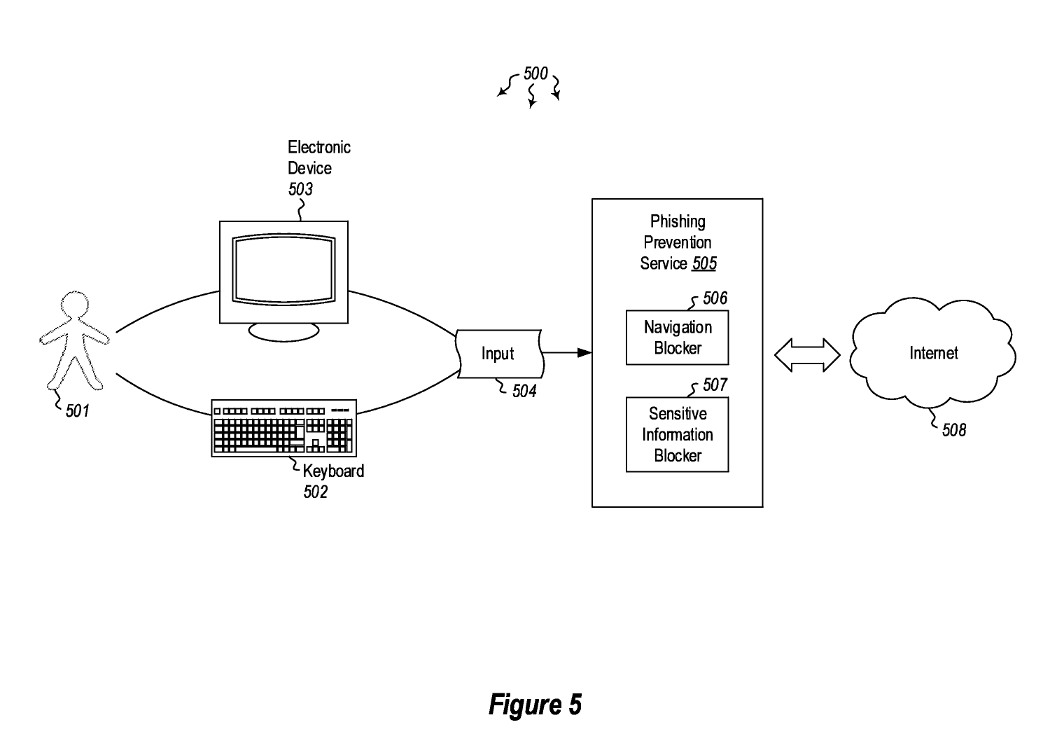

FIG. 4 illustrates a flowchart of an alternative method 400 for detecting and preventing phishing attacks. The method 400 will now be described with frequent reference to the components and data of environments 100 and 500 of FIGS. 1 and 5, respectively.

Method 400 includes an act of identifying one or more portions of sensitive information associated with a user (act 410). For example, sensitive information identifying module 113 may identify sensitive information associated with a user such as the user's user names and passwords, financial information (e.g. bank account or credit card numbers), medical information or other types of non-public information that the user would want to hold private. The sensitive information identifying module 113 may identify this type of information using keywords, using information about the user gleaned over time as the user has interacted with a browser, email application or other application, using known number sequences (e.g. to identify credit card numbers), or using other text patterns or fields.

Method 400 next includes an act of receiving a server request indicating that one or more portions of data are to be transferred to a server including at least one portion of sensitive information (act 420). The server request may be received by an intervening service or may be received at the user's computer system. The determining module 110 may determine the destination address indicating where the sensitive information is to be sent (act 430), determine that the destination address is unlisted within a known-safe list (act 440), and trigger a warning to indicate that the received server request includes sensitive data and is being sent to a location that is not known to be safe (act 450). The warning generating module 112 of computer system 101 may generate the warning which notifies the user that potentially sensitive information is about to be transferred and questions the user whether they wish to continue. The warning may also display the destination domain and/or full URL to further help the user make the judgment as to whether to submit the information or not.

In one embodiment, as shown in FIG. 5, a phishing prevention service 505 may be instantiated and may run on user 501's computing system or may run on an intermediary computing system. The user may provide input at their electronic device 503 (such as a smart phone, tablet or laptop), or at another computing system via a physical keyboard 502. The user's input 504 may include sensitive information. The phishing prevention service 505 may be running as part of a browser, or as part of an operating system service, or as part of a web traffic monitoring service that monitors the user's interaction with internet websites 508. The phishing prevention service 505 may include a navigation blocker that blocks navigation to suspicious or known-bad websites, especially those determined by module 110 to have a mismatch between hyperlink display text and hyperlink destination. The phishing prevention service 505 may also include a sensitive information blocker 507 that prevents sensitive information from being transmitted to other internet websites 508 that are deemed to be unsafe or are suspicious in some way.

Thus, the phishing prevention service 505 or the sensitive information blocker 507 may monitor the user's inputs 504 at the computer system and determine that the user's inputs include sensitive information. This sensitive information associated with the user may be identified using keywords, phrases or number sequences or other methods of identifying certain types of information. Upon determining that the sensitive information is to be sent to a destination that is not listed in a known-safe list, the phishing prevention service 505 may log one or more portions of information regarding the destination address and/or regarding which sensitive information was to be sent. The phishing prevention service may further store and/or publish the destination address as a phishing web site so that others may be aware of the site's nature. If any sensitive information is to be sent to a destination that is not listed in a known-safe list, the sensitive information blocker 507 will prevent the sensitive information from being sent to the destination address, and may further notify the user that data loss to a suspected phishing web site was prevented.

Accordingly, methods, systems and computer program products are provided which detect and prevent phishing attacks. The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A computer system comprising the following:
one or more processors;
one or more computer-readable storage media having stored thereon computer-executable instructions that, when executed by the one or more processors, cause the computing system to perform a method for detecting and preventing a phishing attack, the method comprising the following:
an act of accessing at least one message;
an act of analyzing content in the message to determine whether a link is present, the link having a link destination and at least a portion of text that is designated for display in association with the link, the text designated for display indicating a specified destination;
upon determining that at least one link is present in the message, an act of determining whether the link destination matches the destination specified by the text designated for display; and
upon determining that the destination specified by the text designated for display does not match the link destination, an act of flagging the message to indicate that the message includes at least one suspicious link.

2. The computer system of claim 1, wherein flagging the message to indicate that the message includes at least one suspicious link triggers a notification notifying a message recipient that the message is not to be opened or that the link is not to be followed.

3. The computer system of claim 1, wherein users are prevented from interacting with links in messages flagged as suspicious.

4. The computer system of claim 1, further comprising:
an act of generating logging information to log one or more details related to the message determined to include at least one suspicious link; and
an act of storing the generated logging information in a data store.

5. The computer system of claim 4, further comprising an act of transmitting the generated logging information to a specified entity.

6. The computer system of claim 1, further comprising determining whether the link destination is associated with a location that is known to be safe or known to be unsafe.

7. The computer system of claim 1, wherein the triggered warning displays an indication of the specified link's actual link destination.

8. The computer system of claim 7, further comprising:
an act of receiving an input indicating that a specified link destination is known to be safe; and
an act of preventing subsequent messages that include the specified link destination from being flagged.

9. The computer system of claim 8, wherein the specified link destinations is added to a list of known safe link destinations.

10. At a computer system including at least a processor, a computer-implemented method for detecting and preventing phishing attacks, the method comprising:
an act of receiving an indication indicating that a specified link has been selected, the link having a link destination and at least a portion of text that is designated for display in association with the link, the text designated for display indicating a specified destination;
an act of determining whether the link destination matches the destination specified by the text designated for display; and
upon determining that the destination specified by the text designated for display does not match the link destination, an act of triggering a warning to indicate that the link is suspicious.

11. The method of claim 10, wherein the indication indicating that a specified link has been selected is received at a web browser application, the indication being triggered by at least one user interaction with the web browser application.

12. The method of claim 11, wherein upon determining that the destination specified by the text designated for display does not match the link destination, the web browser application prevents the user's interaction with the web browser from navigating to the link.

13. The method of claim 10, wherein the warning indicating that the link is suspicious is suppressible by a user upon determining that the link destination is a known safe destination.

14. At a computer system including at least a processor and a memory, a computer-implemented method for detecting and preventing phishing attacks, the method comprising:
an act of identifying one or more portions of sensitive information associated with a user;
an act of receiving a server request indicating that one or more portions of data are to be transferred to a server including at least one portion of sensitive information;
an act of determining a destination address indicating where the at least one portion of sensitive information is to be sent;
an act of determining that the destination address is unlisted within a known-safe list; and
upon determining that the at least one portion of sensitive information is to be sent to a destination that is not listed in the known-safe list, an act of triggering a warning to indicate that the received server request includes sensitive data and is being sent to a location that is not known to be safe.

15. The method of claim 14, further comprising:
an act of monitoring the user's inputs at the computer system; and
an act of determining that the user's inputs have caused sensitive information to be input at the computer system.

16. The method of claim 14, wherein the one or more portions of sensitive information associated with the user are identified using keywords, phrases or number sequences.

17. The method of claim 14, further comprising, upon determining that the at least one portion of sensitive information is to be sent to a destination that is not listed in the known-safe list, logging one or more portions of information regarding the destination address.

18. The method of claim 17, further comprising publishing the destination address as a phishing web site.

19. The method of claim 14, further comprising, upon determining that the at least one portion of sensitive information is to be sent to a destination that is not listed in the known-safe list, preventing the at least one portion of sensitive information from being sent to the destination address.

20. The method of claim 19, further comprising notifying the user that data loss to a suspected phishing web site was prevented.
